(19) United States
(12) Patent Application Publication
(10) Pub. No.: US 2014/0026999 A1
(43) Pub. Date: Jan. 30, 2014

(54) EXHAUST DIFFUSER FOR A GAS TURBINE ENGINE HAVING CURVED AND OFFSET STRUTS

(71) Applicants: Javier Leonardo Frailich, Chula Vista, CA (US); Christopher Zdzislaw Twardochleb, Alpine, CA (US); Jiang Luo, San Diego, CA (US)

(72) Inventors: Javier Leonardo Frailich, Chula Vista, CA (US); Christopher Zdzislaw Twardochleb, Alpine, CA (US); Jiang Luo, San Diego, CA (US)

(73) Assignee: SOLAR TURBINES INCORPORATED, San Diego, CA (US)

(21) Appl. No.: 13/558,161

(22) Filed: Jul. 25, 2012

(51) Int. Cl. F15D 1/04

(52) U.S. Cl. 138/39

(57) ABSTRACT

An exhaust diffuser having an outer turbine mounting interface, an outer exhaust collector mounting interface, an outer diffuser wall extending between the outer turbine mounting interface and the outer exhaust collector mounting interface, an inner turbine mounting interface, an inner exhaust collector mounting interface, an inner diffuser wall extending between the inner turbine mounting interface and the inner exhaust collector mounting interface, and a plurality of struts circumferentially distributed around the center axis and extending between the outer diffuser wall and the inner diffuser wall, wherein each of the plurality of struts is radially curved between the diffuser flow outer wall and the diffuser flow inner wall, respectively, and wherein the termination points of each strut is outer wall interface are radially offset from each other.

### TECHNICAL FIELD

The present disclosure generally pertains to gas turbine engines, and is more particularly directed toward a gas turbine exhaust diffuser.

### BACKGROUND

A gas turbine engine generates high-temperature high-velocity exhaust gas. The kinetic energy in the exhaust gas is slowed and converted to static pressure by a diffuser before it is released to the atmosphere. Components subjected to hot exhaust gas may experience thermal expansion. Thermal expansion of fixed structures may result in thermal cycling. In addition, being fixed, even modest thermal expansion may result in interface stresses that invite the design of stronger, often larger structures. The exhaust diffuser serves to reduce the speed of the exhaust flow and hence recovers static pressure along its flow path. Because of pressure recovery in the diffuser, the turbine inlet-to-exit pressure ratio is increased, resulting in higher power and efficiency.

Presently, U.S. Pat. App. Pub. No. 2011/00020166 to Hashimoto et al. describes an axial gas turbine exhaust diffuser having a plurality of strut covers that form sealed cooling chambers. The axial gas turbine exhaust diffuser is located between an outer casing wall and an inner bearing case. Hashimoto et al. further describes a plurality of support struts extending between the outer casing and the inner bearing casing, passing through the sealed strut covers and cooling chambers of the exhaust diffuser, wherein the struts include rounded ends and are coupled to a tubular interface at the inner bearing case, and a tangential direction, such that the inner bearing may rotate relative to the center axis. Relative to expansion and contraction of the struts, one end side and the other end side of the partition wall supporting member are movably provided relative to the extending direction of the struts, and the partition wall follows the expansion and contraction of the struts.

The present disclosure is directed toward overcoming one or more of the problems discussed above as well as additional problems discovered by the inventor.

### SUMMARY OF THE DISCLOSURE

An exhaust diffuser for a gas turbine engine is disclosed herein. The exhaust diffuser having an outer turbine mounting interface, an outer exhaust collector mounting interface, an outer diffuser wall extending between the outer turbine mounting interface and the outer exhaust collector mounting interface, an inner turbine mounting interface, an inner exhaust collector mounting interface, an inner diffuser wall extending between the inner turbine mounting interface and the inner exhaust collector mounting interface, and a plurality of struts circumferentially distributed around the center axis and extending between the outer diffuser wall and the inner diffuser wall. Each of the plurality of struts is joined to the outer diffuser wall at an outer wall interface and joined to the inner diffuser wall at an inner wall interface. Each of the plurality of struts is radially curved between the outer wall interface and the inner wall interface, respectively. Each outer wall interface is radially offset from its respective inner wall interface.

### BRIEF DESCRIPTION OF THE DRAWINGS

FIG. 1 is a schematic illustration of an exemplary gas turbine engine.

FIG. 2 is an axial view of a gas turbine engine exhaust diffuser.

FIG. 3 is a cutaway side view of the gas turbine engine exhaust diffuser of FIG. 2, taken along line 3-3 of FIG. 2.

### DETAILED DESCRIPTION

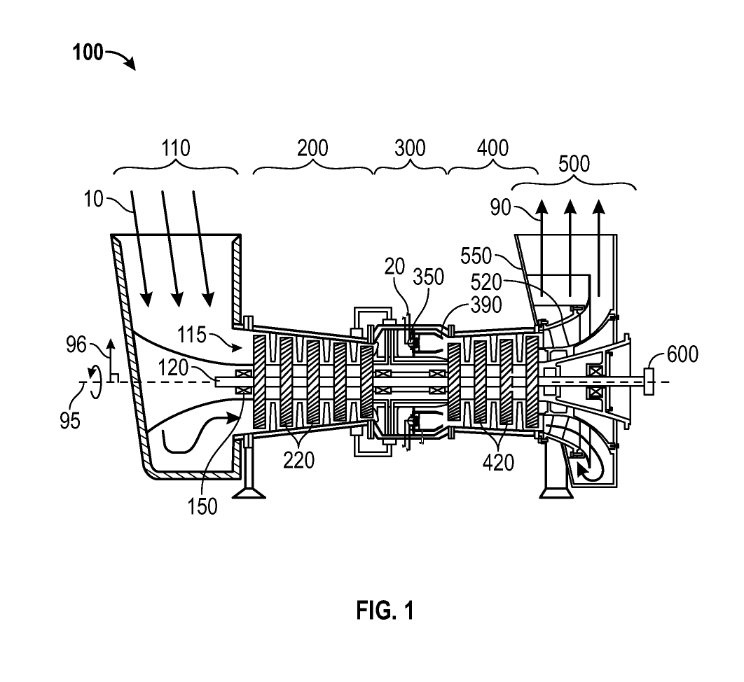

FIG. 1 is a schematic illustration of an exemplary industrial gas turbine engine. Some of the surfaces have been left out or exaggerated (here and in other figures) for clarity and ease of explanation. Also, the disclosure will generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

Structurally, a gas turbine engine 100 includes an inlet 110, a gas producer or “compressor” 200, a combustor 300, a turbine 400, an exhaust 500, and a power output coupling 600. The compressor 200 includes one or more compressor rotor assemblies 220. The combustor 300 includes one or more injectors 350 and includes one or more combustion chambers 390. The turbine 400 includes one or more turbine rotor assemblies 420. The exhaust includes an exhaust diffuser 520 and an exhaust collector 550.

Functionally, a gas (typically air 10) enters the inlet 110 as a “working fluid”, and is compressed by the compressor 200. In the compressor 200, the working fluid is compressed in an annular flow path 115 by the series of compressor rotor assemblies 220. In particular, the air 10 is compressed in numbered “stages”, the stages being associated with each compressor rotor assembly 220. For example, “5th stage air” may be associated with the 5th compressor rotor assembly 220 in the downstream or “aft” direction—going from the inlet 110 towards the exhaust 500). Other numbering/naming conventions may also be used. Stages are similarly associated with each turbine rotor assembly 420

Once compressed air 10 leaves the compressor 200, it enters the combustor 300, where it is diffused and fuel 20 is added. Air 10 and fuel 20 are injected into the combustion chamber 390 via injector 350 and ignited. After the combustion reaction, energy is then extracted from the combusted fuel/air mixture via the turbine 400 by each stage of the series of turbine rotor assemblies 420. Exhaust gas 90 may then be diffused in exhaust diffuser 520 and collected, redirected, and exit the system via an exhaust collector 550. Exhaust gas 90 may also be further processed (e.g., to reduce harmful emissions, and/or to recover heat from the exhaust gas 90).

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

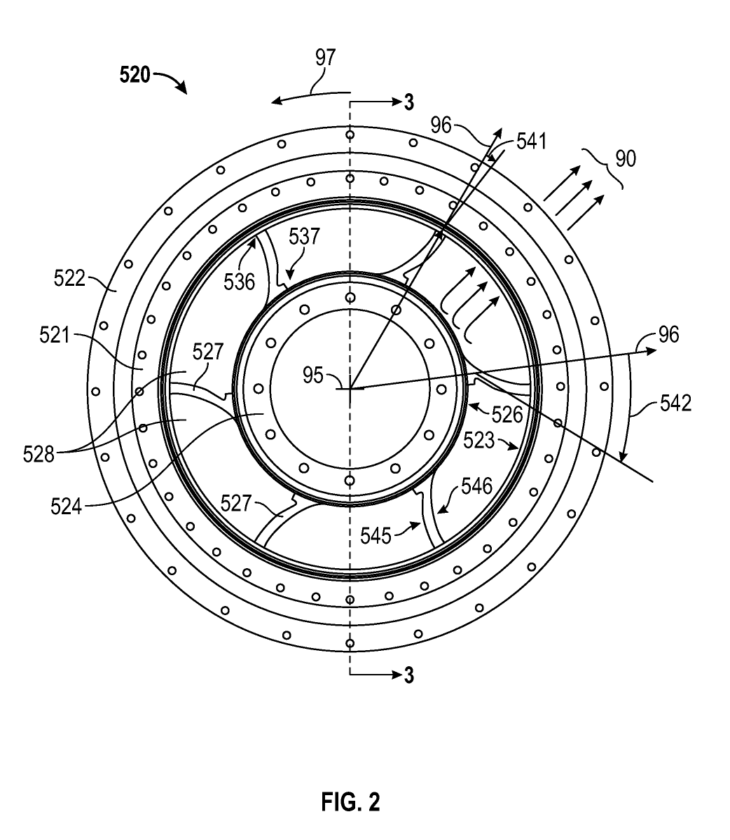

FIG. 2 is an axial view of a gas turbine engine exhaust diffuser. In particular, the exhaust diffuser 520 schematically illustrated in FIG. 1 is shown here in greater detail, but in isolation from the rest of gas turbine engine 100. In general, exhaust diffuser 520 may be conceptualized as two concentric structures (e.g., tubes), joined to each other via a plurality of struts 527 circumferentially distributed around the center axis 95. Here, the concentric structures include the outer diffuser wall 523 and the inner diffuser wall 526. Accordingly, the inner diffuser wall 526 may generally have a smaller diameter than the outer diffuser wall 523. Thus, together, the outer diffuser wall 523 and the inner diffuser wall 526 may provide an annular exhaust flow path 528 between the turbine 400 (FIG. 1) and the exhaust collector 550 (FIG. 1), interrupted by only the struts 527 themselves.

With regard to the plurality of struts 527, each strut 527 may extend between the outer diffuser wall 523 and the inner diffuser wall 526. Each of the plurality of struts 527 may be joined to the outer diffuser wall 523 at an outer wall interface 536 and joined to the inner diffuser wall 526 at an inner wall interface 537, respectively.

Here, outer wall interface 536 and the inner wall interface 537 are merely descriptive of the location of the strut/wall juncture, as opposed to the manner in which the components are joined. For example, the outer diffuser wall 523, the inner diffuser wall 526, and strut 527 may be formed together as a single unit from a single material (e.g., cast as a single investment casting) or joined together as individually made components (e.g., welded or fastened together otherwise).

Independent of the method of forming their juncture at the outer wall interface 536 and the inner wall interface 537, the struts 527 form a structural part of the exhaust diffuser 520, positioning and supporting the outer diffuser wall 523 and the inner diffuser wall 526 relative to each other, while providing passageways for the hot exhaust gas 90 to pass through. In this way, exhaust diffuser 520 becomes less complex from a maintenance stand point, and may be removed and replaced as a single unit.

In addition, the exhaust diffuser 520 may include features that may mitigate losses associated with the presence of each strut 527 in the flow stream, while still positioning and supporting the outer diffuser wall 523 and the inner diffuser wall 526. According to one embodiment, the total number of struts 527 may be limited to six, thus mitigating losses and airflow disturbances associated with the cumulative presence of a greater number of struts 527. According to another embodiment, and as illustrated, each strut 527 may be placed directly in the stream of exhaust gas 90, without any external ducting or shielding. For example, each strut 527 may be made of a material, such as a corrosion resistant steel or superalloy, selected for both its structural strength as well as its resistance to exposure to the hot exhaust gas 90 leaving the turbine 400 (FIG. 1). According to yet another embodiment, each strut 527 may include an aerodynamic profile in order to further mitigate profile losses associated with the presence of each strut 527 directly in the stream of exhaust gas 90. For example, each strut 527 may include a rounded leading edge, an axially-symmetric body, a tapered trailing edge, and a zero or near zero angle of attack, relative to the flow of the exhaust gas 90.

As illustrated, each of the plurality of struts 527 may be radially curved between its respective outer wall interface 536 and its inner wall interface 537. In particular, when viewed from the axial direction (here, looking downstream), each strut 527 may form a curved shape, i.e., without inflection points in a plane perpendicular to the center axis 95. The radial curvature of the strut 527 may be such that at least a portion of the stresses local to the outer wall interface 536 and/or the inner wall interface 537 due to thermal expansion of the strut 527 are taken up within the strut 527. For example, had strut 527 been without any radial curvature (i.e. a straight line between the outer wall interface 536 and the inner wall interface 537), stresses caused by thermal expansion of the strut 527 could be efficiently transferred directly to the outer wall interface 536 and/or the inner wall interface 537. However, by including at least a minimum curvature to the strut 527, at least some of those stresses may be distributed into the curved region, mitigating interface stresses of thermal expansion. According to one embodiment, the curvature of strut 527 may be defined by a second order polynomial tailored to the particular dimensions and thermal and performance specifications of the exhaust diffuser 520. For example, the curvature of strut 527 may be defined by the equation Y=1.3975X̂2+3.2802X+6.4951.

Also, having a simple curvature as described above, the radial curve of each strut 527 may include a convex side 545 and a concave side 546. As illustrated, the convex side 545 may include supplemental support structure at or near its base, i.e., at both its outer wall interface 536 and its inner wall interface 537. It is understood, however, that with regard to describing the radial curvature of the strut 527, the additional shape of said supplemental support structure may be disregarded. Furthermore, the radial curvature of the strut 527 may be measured by the curvature of its concave side 546 since, at both its outer wall interface 536 and its inner wall interface 537, the radial curvature of the strut 527 remains substantially the same as the curvature of its concave side 546. This may be desirable, for example, where measurement through a centerline of the strut 527 is undesired or inconvenient.

According to one embodiment, the radial curvature of strut 527 may vary along the path between the outer wall interface 536 and the inner wall interface 537. In particular, the bend radius of the strut 527 at one point may be different from the bend radius of the strut 527 at another point. For example, the strut 527 may be substantially straight at or near its outer wall interface 536, but smoothly transition to its maximum curvature at or near its inner wall interface 537. In addition, the radial curvature of strut 527 may be used to set a strut outer angle 541 and or a strut inner angle 542, as discussed further below.

According to one embodiment, the radial curvature of the strut 527 may be oriented relative to the direction of residual swirl 97. After the last turbine stage, in addition to having a predominantly axial flow, exhaust gas 90 may have a circumferential velocity component or “residual swirl”. Here direction of residual swirl 97 is represented as counter clockwise (CCW). It is understood that residual swirl of the exhaust gas 90 may be nominal, in the opposite direction, and/or variable.

According to one embodiment the strut 527 may be oriented such that its convex side 545 faces against the direction of residual swirl 97, and its concave side 546 faces in the direction of residual swirl 97. It is understood that the CCW direction of residual swirl 97 is merely exemplary and not limiting to the disclosure. For example, according to this embodiment, had the direction of residual swirl 97 been CW, the strut 527 could be flipped about a radial 96 passing though either end point (outer wall interface 536 or inner wall interface 537 outer wall interface 536 and the inner wall interface 537).

Also as illustrated, each outer wall interface 536 may be radially offset from its respective inner wall interface 537. In particular, when viewed from the axial direction as shown, the outer wall interface 536 may reside on a different radial 96 than its respective inner wall interface 537. In this way, thermal expansion of the strut 527 during engine operation may tangentially translate loads that would otherwise be normal to the outer diffuser wall 523 and the inner diffuser wall 526 into the outer diffuser wall 523 and the inner diffuser wall 526 in a circumferential direction. Thus, thermal expansion interface stresses may be converted to rotation, torsion, and/or distributed across larger structures such as their respective mounting interfaces.

According to one embodiment, the strut 527 may meet the outer diffuser wall 523 at a normal angle or at a non-normal angle (i.e., non-perpendicular to a tangent plane of the outer diffuser wall 523). In particular, strut 527 may interface with the diffuser flow outer wall 526 at a strut outer angle 541 set such that the thermal expansion of strut 527 during engine operation will result in sufficient translation/transfer of interface stresses at its outer wall interface 536 to the outer diffuser wall 523, which may be taken up by its material properties as a minor torque applied between the outer diffuser wall 523 and the inner diffuser wall 526. For example, according to one embodiment, the strut 527 may interface with the outer diffuser wall 523 at a strut outer angle 541 within the range of plus 10 degrees to minus 10 degrees from normal.

As discussed above, the radial curvature of strut 527 may be coordinated/varied with the outer diffuser wall 523 to provide or set the desired strut outer angle 541. In addition, as discussed below, where interface stress is sufficiently taken up elsewhere, the strut outer angle 541 may approach normal, or zero degrees. Here, the strut outer angle 541 is represented as an extrapolation of the general direction of the strut 527 at its outer wall interface 536. The general direction may be taken through the middle of the strut 527, neglecting any additional structures (e.g., fillets or chamfers) local to the outer wall interface 536. Alternately, as can be seen, the strut outer angle 541 may be conveniently approximated by the tangent to the curve of the strut 527 on its concave side 546, also neglecting any additional structure local to the outer wall interface 536.

According to one embodiment, the strut 527 may meet the inner diffuser wall 526 at a non-normal angle (i.e., non-perpendicular to a tangent plane of the inner diffuser wall 526). In particular, strut 527 may interface with the inner diffuser wall 526 at a strut inner angle 542 such that the thermal expansion of strut 527 during engine operation will result in sufficient translation/transfer of interface stresses at its inner wall interface 537 to the inner diffuser wall 526, which may be taken up by material properties as a minor torque applied between the outer diffuser wall 523 and the inner diffuser wall 526.

Unlike the strut outer angle 541, the strut inner angle 542 may significantly depart a normal (perpendicular) angle. For example, according to one embodiment, the strut 527 may interface with the inner diffuser wall 526 at a strut inner angle 542 within the range of 20 degrees to 40 degrees from normal. As above, the strut inner angle 542 is represented as an extrapolation of the general direction of the strut 527 at its inner wall interface 537. The general direction may be taken through the middle of the strut 527, neglecting any additional structures local to the outer wall interface 536. Alternately, as can be seen, the strut outer angle 541 may be conveniently approximated by the tangent to the curve of the strut 527 on its concave side 546, also neglecting any additional structures local to the inner wall interface 537.

In addition, and similar to its radial curvature, a strut inner angle 542 may take in account the direction of residual swirl 97. In particular, the strut 527 may interface with the inner diffuser wall 526 at a strut inner angle 542 within the range of 20 degrees to 40 degrees from normal as measured in the direction against the direction of residual swirl 97 (here in the CW direction). As discussed above, the radial curvature of strut 527 may be coordinated/varied with the inner diffuser wall 526 to provide or set the desired strut inner angle 542.

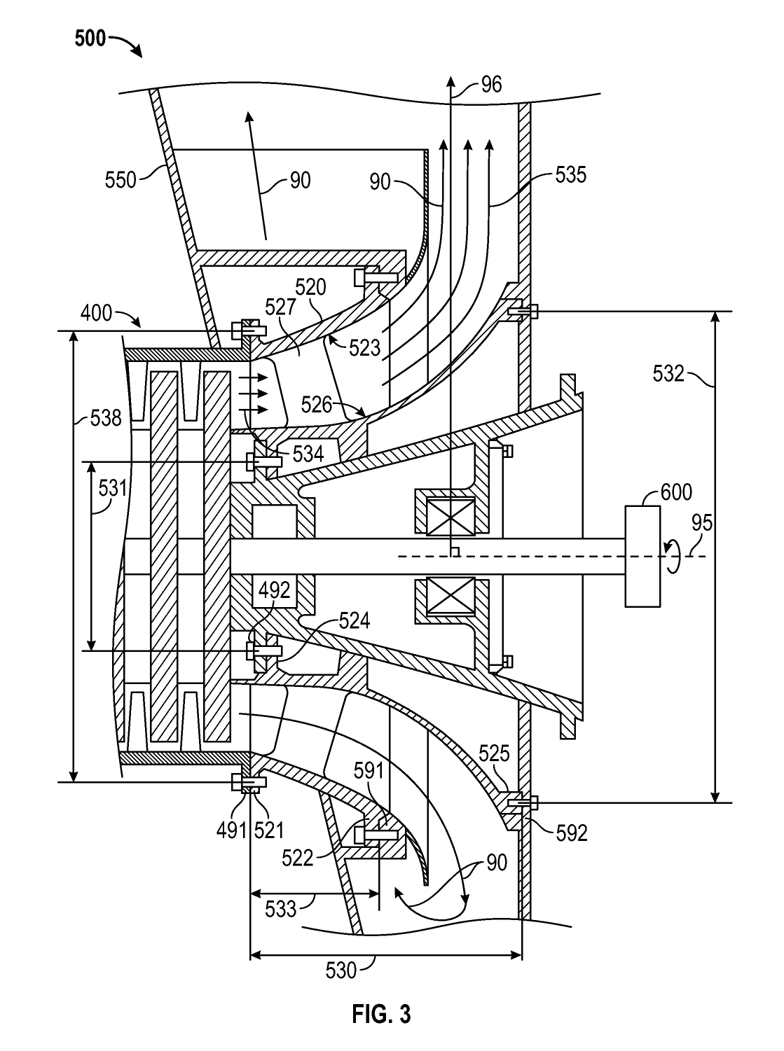

FIG. 3 is a cutaway side view of a gas turbine engine exhaust diffuser as taken along line 3-3 of FIG. 2, with the addition of partial views of its mounting components for contextual purposes. As discussed above, exhaust diffuser 520 may conceptualized as two concentric structures (e.g., tubes), joined to each other via a plurality of struts 527. Exhaust diffuser 520 may be in axial configuration, a radial configuration, or a combination thereof. In the currently illustrated radial configuration, exhaust diffuser 520 will generally have a much shorter axial length, as a whole, than if it were in an axial diffuser configuration.

As illustrated, exhaust diffuser 520 receives hot exhaust gas 90 from the turbine 400 in a predominantly axial flow 534 (i.e., in the direction of the center axis 95), imparts a radial component (i.e., in the direction of a radial 96 off the center axis 95) to the exhaust gas 90, and transmits a predominantly radial flow 535 or outward flow downstream into the exhaust collector 550. Exhaust collector 550 may then “collect” the exhaust gas 90 and direct it away in a single, convenient direction. Notably, since the hot exhaust gas 90 is largely redirected by its inner diffuser wall 526 in the illustrated configuration, transfer of heat and impingement force to the inner diffuser wall 526 may be greater than in an axial diffuser configuration.

With regard to the outer structure discussed above, exhaust diffuser 520 may include an outer turbine mounting interface 521, an outer exhaust collector mounting interface 522, and the outer diffuser wall 523. The outer diffuser wall 523 may be generally tubular in shape, and extend between the outer turbine mounting interface 521 and the outer exhaust collector mounting interface 522.

With regard to the inner structure, the exhaust diffuser 520 may include an inner turbine mounting interface 524, an inner exhaust collector mounting interface 525, and the inner diffuser wall 526. The inner diffuser wall 526 may also be generally tubular in shape (here, with a flared end), and extend between its inner turbine mounting interface 524 and inner exhaust collector mounting interface 525.

Being a radial diffuser, features of the inner diffuser wall 526 may differ significantly from those of outer diffuser wall 523. In particular, the axial length 530 of the inner diffuser wall 526 may be greater than the axial length 533 of the outer diffuser wall 523. The axial length of each wall may conveniently be measured from interfacing surfaces of each end. The additional length providing for a transitional area where exhaust gas 90 changes direction from a predominantly axial flow 534 to a predominantly radial flow 535. Accordingly, the inner diffuser wall 526 may curve outward and provide the radial component to the exhaust gas 90.

Also, the diameter 532 of the inner exhaust collector mounting interface 525 may be greater than the diameter 531 of the inner turbine mounting interface 524. Moreover, the diameter 532 of the inner exhaust collector mounting interface 525 may be greater than or equal to the diameter 538 of the outer turbine mounting interface 521. Referring also to FIG. 2, the diameter of each interface may conveniently be measured through the center of its respective fasteners. Alternately, the diameter of each interface may conveniently be measured at its outermost radial distance. The flared out inner diffuser wall 526 cumulating with the increased diameter 532 at its inner exhaust collector mounting interface 525 provides for the inner diffuser wall 526 to impart redirective forces on the exhaust gas 90, changing its flow direction and to transmit a predominately radial flow in 360 degrees to the exhaust collector 550.

Upon installation, both the inner and outer diffuser walls 526, 523 may be mechanically and fluidly coupled to the turbine 400 and the exhaust collector 550 via their respective mounting interfaces. In particular and as illustrated here and in FIG. 2, the outer turbine mounting interface 521 and the outer exhaust collector mounting interface 522 may each include a generally circular shaped ring that is part of (e.g., machined into) or joined to the outer diffuser wall 523. Each ring may include fastening points such as a plurality of bolt holes circumferentially distributed around each ring. Accordingly, both outer interface rings may then be bolted to a mating interface, such as an outer turbine diffuser mounting flange 491 or an Outer exhaust collector diffuser mounting flange 591.

Also as illustrated, the inner turbine mounting interface 524 and the inner exhaust collector mounting interface 525 may each include a circular ring that is part of (e.g., machined into) or joined to the inner diffuser wall 526. Each ring may include fastening points such as a plurality of bolt holes circumferentially distributed around each ring. Accordingly, both interface rings may then be bolted to a mating interface, such as an inner turbine diffuser mounting flange 492 or an inner exhaust collector diffuser mount 592.

### INDUSTRIAL APPLICABILITY

The present disclosure generally provides an exhaust diffuser, and a gas turbine engine having an exhaust diffuser. As applied, gas turbine engines, and thus their components, may be suited for any number of industrial applications, such as, but not limited to, various aspects of the oil and natural gas industry (including transmission, gathering, storage, withdrawal, and lifting of oil and natural gas), power generation industry, aerospace and transportation industry, to name a few examples.

The disclosed exhaust diffuser is generally applicable to any gas turbine engine having an exhaust diffuser. This includes radial flow exhaust diffusers, axial flow exhaust diffusers, and hybrids thereof. As described, the exhaust diffuser is particularly suited for applications calling for a radial gas diffuser, which may have shorter axial lengths and strong flow turning.

Additionally, the disclosed exhaust diffuser is particularly applicable to the use, operation, maintenance, repair, and improvement of gas turbine engines. Specifically, the exhaust diffuser may be suited for the design, manufacture, test, repair, overhaul, and improvement of exhaust diffusers where relief of strut thermal expansion would be desirable. For example, compared to an exhaust diffuser having many radial struts that are interfaced normal to the inner and outer diffuser walls, interface stresses associated with thermal expansion of the struts may be mitigated by being distributed into the curvature of the struts and/or being translated from a shear and normal force taken up at the strut interface, to a rotational force taken up across the exhaust diffuser interfaces (or otherwise). This is beneficial as struts, having a lower mass and being placed directly in the exhaust stream, may heat up and thermally expand before its surrounding casing.

In order to improve efficiency, decrease maintenance, and lower costs, embodiments of the presently disclosed exhaust diffuser may be used on exhaust systems at any stage of the gas turbine engine's life, from first manufacture and prototyping to end of life. In addition, the simplified design, with integrated struts, may outperform and be easier to build and maintain that more complicated and bulky actively cooled exhaust diffuser systems. Accordingly, the disclosed exhaust diffuser may be used as an enhancement to existing gas turbine engine exhaust diffuser, as a preventative measure, or even in response to an event. This is particularly true as the presently disclosed exhaust diffuser may conveniently include identical mounting interfaces to an older type of exhaust diffuser.

Although this invention has been shown and described with respect to a detailed embodiment thereof, it will be understood by those skilled in the art that various changes in form and detail thereof may be made without departing from the spirit and scope of the claimed invention. Accordingly, the preceding detailed description is merely exemplary in nature and is not intended to limit the invention or the application and uses of the invention. In particular, the described embodiments are not limited to use in conjunction with a particular type of gas turbine engine. For example, the described embodiments may be applied to stationary or motive gas turbine engines, or any variant thereof. It will be recognized that in some instances the described embodiments may also be used in other machines that also produce high temperature, high speed exhaust air. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

What is claimed is:

1. An exhaust diffuser for a gas turbine engine, the exhaust diffuser comprising:
an outer turbine mounting interface;
an outer exhaust collector mounting interface;
an outer diffuser wall extending between the outer turbine mounting interface and the outer exhaust collector mounting interface, the outer diffuser wall having a center axis;
an inner turbine mounting interface;
an inner exhaust collector mounting interface;
an inner diffuser wall extending between the inner turbine mounting interface and the inner exhaust collector mounting interface, the inner diffuser wall coaxial with the outer diffuser wall; and
a plurality of struts circumferentially distributed around the center axis and extending between the outer diffuser wall and the inner diffuser wall, each of the plurality of struts joined to the outer diffuser wall at an outer wall interface and joined to the inner diffuser wall at an inner wall interface, wherein each of the plurality of struts is radially curved between the outer wall interface and the inner wall interface, respectively, and wherein each outer wall interface is radially offset from its respective inner wall interface.

2. The exhaust diffuser of claim 1, wherein each of the plurality of struts meets the inner diffuser wall at its respective inner wall interface at a strut inner angle; and
wherein the strut inner angle is not zero degrees.

3. The exhaust diffuser of claim 2, wherein the strut inner angle is between 20 degrees and 40 degrees.

4. The exhaust diffuser of claim 2, wherein each of the plurality of struts meets the outer diffuser wall at its respective outer wall interface at a strut outer angle; and
wherein the strut outer angle is between 10 degrees and minus 10 degrees.

5. The exhaust diffuser of claim 2, wherein each of the radially curved plurality of struts has a convex side and a concave side; and
wherein each convex side faces against the direction of residual swirl and each concave side faces in the direction of residual swirl.

6. The exhaust diffuser of claim 1, wherein the plurality of struts number six or fewer.

7. The exhaust diffuser of claim 1, wherein the outer diffuser wall has a first axial length;
wherein the inner diffuser wall has a second axial length, the second axial length greater than the first axial length;
wherein the inner turbine mounting interface has a first diameter;
wherein the inner exhaust collector mounting interface has a second diameter, the second diameter greater than the first diameter; and
wherein the exhaust diffuser is configured to receive exhaust gas in a predominantly axial flow, impart a radial direction to the exhaust gas, and transmit a predominantly radial flow.

8. The exhaust diffuser of claim 1, wherein at least the outer diffuser wall, the inner diffuser wall, and the plurality of struts are formed together as a single unit from a single material.

9. The exhaust diffuser of claim 8, wherein at least the outer diffuser wall, the inner diffuser wall, and the plurality of struts are cast as a single investment casting.

10. A gas turbine engine having a center axis and a direction of residual swirl, the gas turbine engine comprising:
a turbine including an outer turbine diffuser mounting flange; and
an exhaust diffuser including
an outer turbine mounting interface, the outer turbine mounting interface mechanically coupled to the outer turbine diffuser mounting flange,
an outer exhaust collector mounting interface,
an outer diffuser wall extending between the outer turbine mounting interface and the outer exhaust collector mounting interface, the outer diffuser wall having a center axis,
an inner turbine mounting interface,
an inner exhaust collector mounting interface,
an inner diffuser wall extending between the inner turbine mounting interface and the inner exhaust collector mounting interface, the inner diffuser wall coaxial with the outer diffuser wall, and
a plurality of struts circumferentially distributed around the center axis and extending between the outer diffuser wall and the inner diffuser wall, each of the plurality of struts joined to the outer diffuser wall at an outer wall interface and joined to the inner diffuser wall at an inner wall interface, wherein each of the plurality of struts is radially curved between the outer wall interface and the inner wall interface, respectively, and wherein each outer wall interface is radially offset from its respective inner wall interface.

11. The gas turbine engine of claim 10, wherein each of the plurality of struts meets the inner diffuser wall at its respective inner wall interface at a strut inner angle measured from normal to the inner diffuser wall and measured in the direction of residual swirl; and
wherein the strut inner angle is not zero degrees.

12. The gas turbine engine of claim 11, wherein the strut inner angle is between 20 degrees and 40 degrees.

13. The gas turbine engine of claim 11, wherein each of the plurality of struts meets the outer diffuser wall at its respective outer wall interface at a strut outer angle measured from normal to the outer diffuser wall and measured in the direction of residual swirl; and
wherein the strut outer angle is between 10 degrees and minus 10 degrees, but not zero degrees.

14. The gas turbine engine of claim 11, wherein each of the radially curved plurality of struts has a convex side and a concave side; and
wherein each convex side faces against the direction of residual swirl and each concave side faces in the direction of residual swirl.

15. The gas turbine engine of claim 10, wherein the plurality of struts number six or fewer.

16. The gas turbine engine of claim 10, wherein the outer diffuser wall includes a first axial length;
wherein the inner diffuser wall includes a second axial length, the second axial length greater than the first axial length;
wherein the inner turbine mounting interface includes a first diameter;
wherein the inner exhaust collector mounting interface includes a second diameter, the second diameter greater than the first diameter; and
wherein the exhaust diffuser receives exhaust gas in a predominantly axial flow, imparts a radial component to the exhaust gas, and transmits a predominantly radial flow.

17. The gas turbine engine of claim 10, wherein at least the outer diffuser wall, the inner diffuser wall, and the plurality of struts are formed together as a single unit from a single material.

19. The gas turbine engine of claim 17, wherein at least the outer diffuser wall, the inner diffuser wall, and the plurality of struts are cast as a single investment casting.
